(19) United States
(12) Patent Application Publication
(10) Pub. No.: US 2008/0100839 A1
(43) Pub. Date: May 1, 2008

(54) Method and system for measuring light propagating at multiple wavelengths

(76) Inventor: Julie E. Fouquet, Portola Valley, CA (US)

Correspondence Address: Kathy Manke;Avago Technologies Limited, 4380 Ziegler Road, Fort Collins, CO, 80525, US

(21) Appl. No.: 11/591,648

(22) Filed: Oct. 31, 2006

(51) Int. Cl. G01J 3/28

(52) U.S. Cl. 356/328

(57) ABSTRACT

A compact light source emits white light towards an optically-active test sample that includes one or more unknown compounds. The unknown compound or compounds absorbs at least some of the light and emits fluorescece or luminescence, or absorbs some of the light while the non-absorbed light transmits through or reflects off the test sample. A wavelength separator receives light from the test sample and discriminates some or all of the wavelengths in the test light. At least a portion of the test light is then detected by a detector array.

### BACKGROUND

Light absorption, fluorescence, and luminescence have been used for many years to better understand the properties of materials. Both the wavelength of the light that is absorbed or emitted and the temporal characteristics of the absorbed or emitted light provide information about a particular compound or material, such as, for example, a chemical compound. Spectrometers, spectroscopes, and spectrophotometers are examples of instruments used to measure the properties of light and identify or obtain information about a particular material.

Spectrometers, spectroscopes, and spectrophotometers can be expensive to purchase and maintain. It is also difficult for some of these instruments to detect many samples of interest because their sensitivity is too low. An auxiliary light source typically improves the sensitivity of an instrument, but auxiliary light sources add to the cost and maintenance expenses of such systems. Auxiliary light sources also tend to be heavy and delicate. The collection optics in an auxiliary light source can be misaligned by simply bumping the source, which results in decreased light output or bulb failure. And finally, auxiliary light sources tend to consume large quantities of electrical power.

### SUMMARY

In accordance with the invention, methods and systems for measuring light propagating at multiple wavelengths are provided. A compact white light source emits white light towards an optically-active test sample that includes one or more unknown compounds. The unknown compound or compounds absorbs some or all of the light and may responsively emit fluorescence or luminescence in an embodiment in accordance with the invention. In other embodiments in accordance with the invention, the compound or compounds absorbs some of the light while the non-absorbed light transmits through or reflects off the optically-active test sample. A wavelength separator receives light from the test sample and discriminates some or all of the wavelengths in the test light. At least a portion of the test light is then detected by a detector array.

### BRIEF DESCRIPTION OF THE DRAWINGS

FIG. 1 is a flowchart of a method for measuring fluorescence or luminescence at multiple wavelengths in an embodiment in accordance with the invention;

FIG. 2 is a graphic illustration of a first system for measuring light propagating at multiple wavelengths in an embodiment in accordance with the invention;

FIG. 3 is a graphic illustration of a second system for measuring light propagating at multiple wavelengths in an embodiment in accordance with the invention;

FIG. 4 is a graphic illustration of a third system for measuring light propagating at multiple wavelengths in an embodiment in accordance with the invention;

FIG. 5 is a graphic illustration of a fourth system for measuring light propagating at multiple wavelengths in an embodiment in accordance with the invention;

FIG. 6 is a graphic illustration of a fifth system for measuring light propagating at multiple wavelengths in an embodiment in accordance with the invention; and

FIG. 7 is a graphic illustration of a sixth system for measuring light propagating at multiple wavelengths in an embodiment in accordance with the invention.

### DETAILED DESCRIPTION

The following description is presented to enable embodiments of the invention to be made and used, and is provided in the context of a patent application and its requirements. Various modifications to the disclosed embodiments will be readily apparent, and the generic principles herein may be applied to other embodiments. Thus, the invention is not intended to be limited to the embodiments shown but is to be accorded the widest scope consistent with the appended claims. Like reference numerals designate corresponding parts throughout the figures.

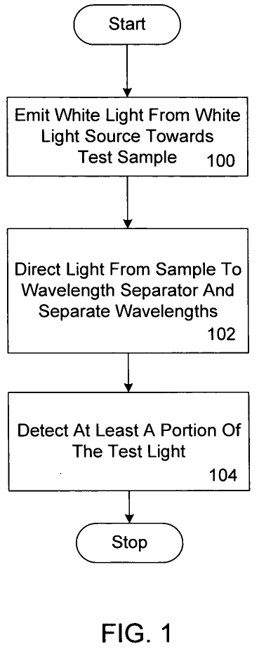

FIG. 1 is a flowchart of a method for measuring light propagating at multiple wavelengths in an embodiment in accordance with the invention. Light from a compact white light source is emitted towards an optically-active test sample, as shown in block 100. The compact white light source occupies a volume equal or nearly equal to ten cubic centimeters or less in an embodiment in accordance with the invention.

The compact white light source is implemented as a white light emitting diode (LED) in an embodiment in accordance with the invention. For example, in one embodiment in accordance with the invention, the white LED is implemented as a short wavelength LED (e.g., blue) illuminating a phosphor that in turn re-emits light at longer visible wavelengths. In other embodiments in accordance with the invention, the compact white light source is implemented with a different type of light source, such as, for example, a compact xenon flash lamp or a compact incandescent lamp.

The test sample includes one or more unknown compounds that are to be identified in an embodiment in accordance with the invention. When the white light strikes the optically-active test sample, the test sample absorbs at least some of the light and may responsively emit fluorescence or luminescence (“test light”) or reflect light (“test light”) in an embodiment in accordance with the invention. In another embodiment in accordance with the invention, the optically-active test sample absorbs light associated with the test sample while light not associated with the test sample is transmitted through the optically-active test sample (“test light”).

The test light is then received by a wavelength separator, as shown in block 102. The wavelength separator splits or discriminates some or all of the wavelengths in the test light into one or more wavelength components. The wavelength separator includes, for example, a diffraction grating, a prism, or a spike filter with a sliding transmission wavelength along its surface in an embodiment in accordance with the invention.

At least a portion of the test light is then detected by a detector array at block 104. Light propagating at each wavelength component is directed in different directions by the diffraction grating or prism such that each wavelength component strikes a different pixel or group of pixels in the detector array. The detector array detects the intensity of light propagating at each received wavelength to identify or obtain information about the unknown compound in the optically-active test sample.

In other embodiments in accordance with the invention, the wavelength separator includes a filter designed to transmit only one or more wavelengths of interest in the test light while simultaneously blocking or not transmitting the other wavelengths in the test light. Light propagating at each wavelength of interest then strikes different pixels or group of pixels in the detector array. The detector array detects the intensity of light propagating at each received wavelength to identify or obtain information about the unknown compound in the optically-active test sample.

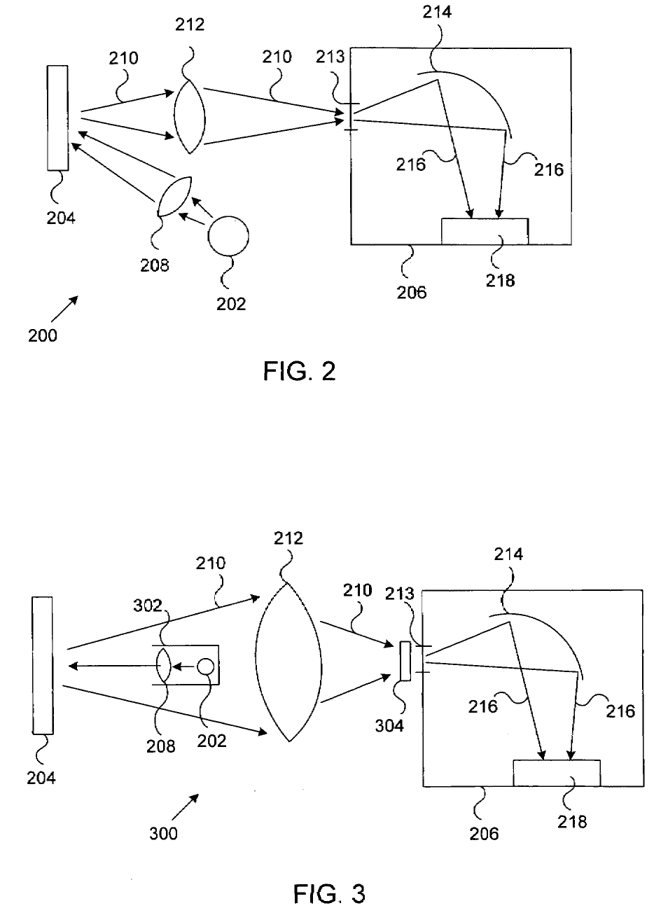

Referring to FIG. 2, there is shown a graphic illustration of a first system for measuring light propagating at multiple wavelengths in an embodiment in accordance with the invention. System 200 includes compact white light source 202, optically-active test sample 204, and spectrometer 206. Compact white light source 202 emits light toward focusing lens 208, which concentrates the light on test sample 204. Optically-active test sample 204 absorbs at least some of the light and emits fluorescence or luminescence (“test light 210”) in response to the white light striking test sample 204. Test light 210 passes through mode-matching lens 212 to converge at the entrance slit 213 of spectrometer 206. Test light 210 then diverges towards curved wavelength separator 214 after passing through entrance slit 213 of spectrometer 206.

Wavelength separator 214 is implemented as an array of parallel groves or rulings formed on a curved reflecting surface in an embodiment in accordance with the invention. By way of example only, curved wavelength separator 214 is implemented as a curved diffraction grating that splits or discriminates test light 210 into its constituent wavelength components 216. The wavelength components are directed in different directions by curved wavelength separator 214 such that each component 216 strikes a different pixel or group of pixels in detector array 218. Detector array 218 is implemented as a linear silicon complementary metal oxide semiconductor detector array in an embodiment in accordance with the invention. Detector array 218 detects the intensity of light propagating at each received wavelength component to identify or obtain information about the unknown compound in the test sample.

All of the wavelength components 216 in test light 210 are wavelengths of interest that provide information about the unknown compound in an embodiment in accordance with the invention. In other embodiments in accordance with the invention, only one wavelength component 216 or a portion of the wavelength components 216 in test light 210 are wavelengths of interest that provide information about the unknown compound in an embodiment in accordance with the invention.

FIG. 3 is a graphic illustration of a second system for measuring light propagating at multiple wavelengths in an embodiment in accordance with the invention. System 300 includes compact white light source 202, optically-active test sample 204, and spectrometer 206. Compact white light source 202 and focusing lens 208 are integrated together within housing 302 in the embodiment of FIG. 3.

Focusing lens 208 concentrates light from compact white light source 202 towards test sample 204. Optically-active test sample 204 absorbs at least some of the light and emits fluorescence or luminescence (“test light 210”) in response to the white light striking test sample 204. Test light 210 passes through mode-matching lens 212 and filter 304 to converge at the entrance slit 213 of spectrometer 206. Filter 304 blocks light scattered at the shorter source wavelengths while transmitting the wavelengths of interest in test light 210 in an embodiment in accordance with the invention.

Test light 210 then diverges towards curved wavelength separator 214 after passing through entrance slit 213 of spectrometer 206. Curved wavelength separator 214 splits or discriminates test light 210 into its constituent wavelength components 216. The wavelength components are directed in different directions by curved wavelength separator 214 such that each component 216 strikes a different pixel or group of pixels in detector array 218. Detector array 218 detects the intensity of light propagating at each received wavelength to identify or obtain information about the unknown compound in the test sample.

Embodiments in accordance with the invention are not limited to the system configurations shown in FIG. 2 and FIG. 3. System 200 and system 300 may be configured with different components in other embodiments in accordance with the invention. For example, spectrometer 206 is implemented with one or more curved mirrors and a flat wavelength separator in another embodiment in accordance with the invention. Additionally, focusing lens 208 and mode-matching lens 212 are implemented with a single lens used to converge test light 210 onto the entrance slit of spectrometer in another embodiment in accordance with the invention. Alternatively, focusing lens 208 and mode-matching lens 212 are implemented with one or more different types of lenses in other embodiments in accordance with the invention.

Additionally, a wavelength filter (not shown) is added in housing 302 on either side of lens 208 to remove the one or more wavelengths of interest from the excitation spectrum in the case of fluorescence or luminescence in an embodiment in accordance with the invention. The wavelength filter improves the performance of the system by eliminating scattered source light propagating at the one or more wavelengths of interest from the detection system that might otherwise overwhelm the wavelength or wavelengths of interest included in the luminescence or fluorescence.

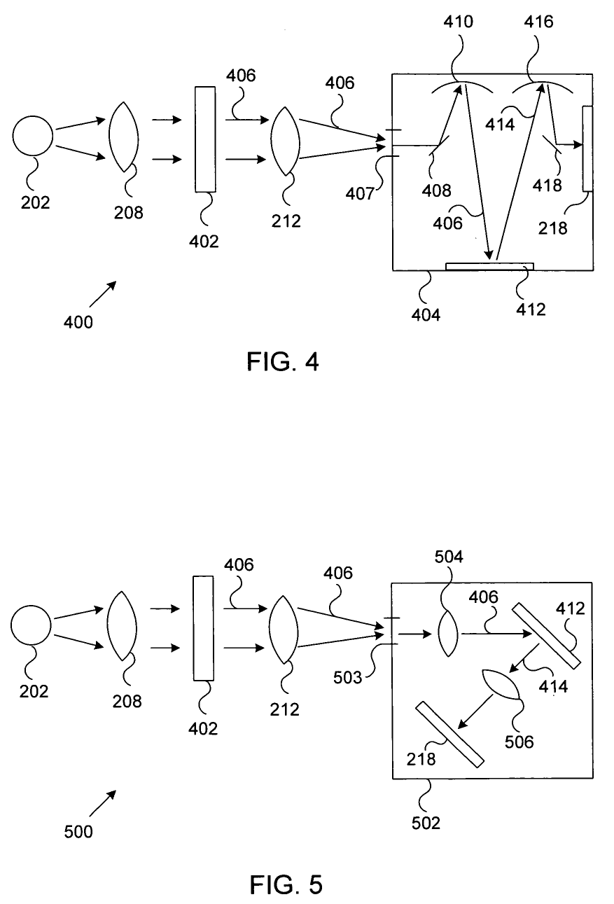

Referring to FIG. 4, there is shown a graphic illustration of a third system for measuring light propagating at multiple wavelengths in an embodiment in accordance with the invention. The embodiment shown in FIG. 4 is well-suited for detecting absorption spectra. System 400 includes compact white light source 202, optically-active test sample 402, and spectrometer 404. Test sample 402 is implemented as a transparent or semi-transparent optically-active test sample that includes one or more unknown compounds in an embodiment in accordance with the invention.

Compact white light source 202 emits light toward focusing lens 208, which concentrates the light towards test sample 402. Optically-active test sample 402 absorbs light propagating at wavelengths associated with the unknown compound or compounds while the non-absorbed light transmits through test sample 402 (“test light 406”). Test light 406 is then transmitted through mode-matching lens 212 and converges at the entrance slit 407 of spectrometer 404.

Test light 406 diverges towards flat mirror 408 after passing through entrance slit 407 of spectrometer 404. Flat mirror 408 and curved mirror 410 direct test light 406 towards flat wavelength separator 412. Flat wavelength separator 412 splits or discriminates test light 406 into its constituent wavelength components 414 that are then directed towards detector array 218 via curved mirror 416 and flat mirror 418, respectively. Each wavelength component 414 strikes a different pixel or group of pixels in detector array 218, thereby allowing detector array 218 to detect the intensity of light propagating at each received wavelength to identify or obtain information about the unknown compound.

All of the wavelength components 414 in test light 406 are wavelengths of interest that provide information about the unknown compound in an embodiment in accordance with the invention. In other embodiments in accordance with the invention, only one wavelength component 414 or a portion of the wavelength components 414 in test light 406 are wavelengths of interest that provide information about the unknown compound in an embodiment in accordance with the invention.

Embodiments in accordance with the invention are not limited to the system configuration shown in FIG. 4. System 400 may be implemented with different components in other embodiments in accordance with the invention. For example, spectrometer 404 is implemented with a curved wavelength separator in another embodiment in accordance with the invention. For example, the wavelength separator may be concave in shape to focus light onto detector array 218, thereby eliminating the need for curved mirrors 410, 416. Additionally, focusing lens 208 and mode-matching lens 212 are implemented with a single lens used to converge test light 406 onto the entrance slit 407 of spectrometer 404 in another embodiment in accordance with the invention. Alternatively, focusing lens 208 and mode-matching lens 212 may be implemented with one or more different types of lenses in other embodiments in accordance with the invention. And finally, a filter may be inserted in front of the entrance slit 407 of spectrometer 404 to block light scattered at the shorter source wavelengths while transmitting the wavelengths of interest in test light 406 in other embodiments in accordance with the invention.

FIG. 5 is a graphic illustration of a fourth system for measuring light propagating at multiple wavelengths in an embodiment in accordance with the invention. System 500 includes compact white light source 202, optically-active test sample 402, and spectrometer 502. Test sample 402 is implemented as a transparent or semi-transparent optically-active test sample that includes an unknown compound in an embodiment in accordance with the invention.

Compact white light source 202 emits light toward focusing lens 208, which concentrates the light towards test sample 402. Optically-active test sample 402 absorbs light propagating at wavelengths associated with the unknown compound while the non-absorbed light transmits through test sample 402 (“test light 406”). Test light 406 is then transmitted through mode-matching lens 212 and converges at the entrance slit 503 of spectrometer 502.

Test light 406 diverges towards focusing lens 504 after passing through the entrance slit 503 of spectrometer 502. Focusing lens 504 directs test light 406 towards flat wavelength separator 412. Flat wavelength separator 412 splits or discriminates test light 406 into its constituent wavelength components 414 that are then directed towards detector array 218 via focusing lens 506. Each wavelength component 414 strikes a different pixel or group of pixels in detector array 218, thereby allowing detector array 218 to detect the intensity of light propagating at each received wavelength to identify or obtain information about the unknown compound.

All of the wavelength components 414 in test light 406 are wavelengths of interest that provide information about the unknown compound in an embodiment in accordance with the invention. In other embodiments in accordance with the invention, only one wavelength component 414 or a portion of the wavelength components 414 in test light 406 are wavelengths of interest that provide information about the unknown compound in an embodiment in accordance with the invention.

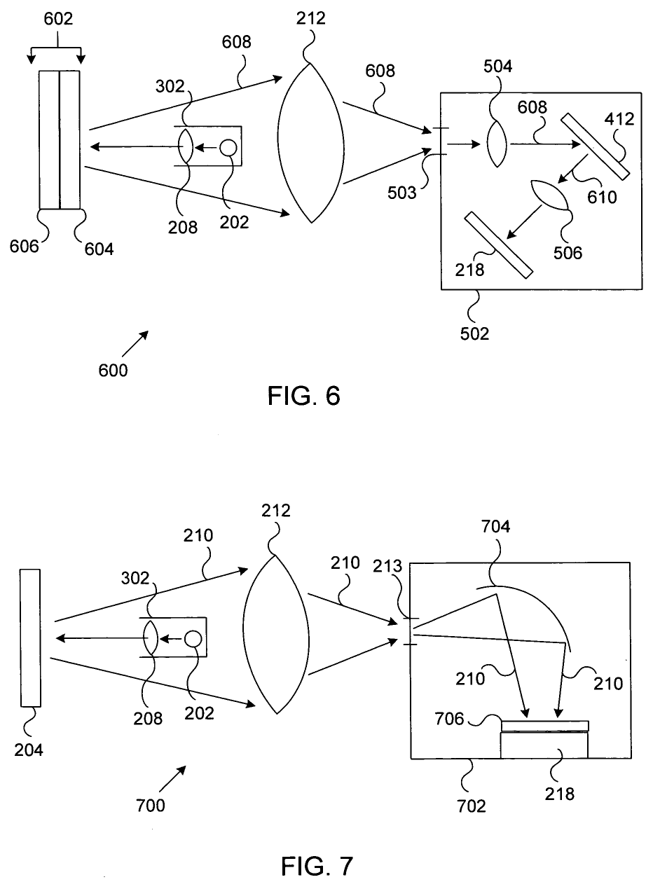

Referring to FIG. 6, there is shown a graphic illustration of a fifth system for measuring light propagating at multiple wavelengths in an embodiment in accordance with the invention. System 600 includes compact white light source 202, optically-active test sample 602, and spectrometer 502. Compact white light source 202 and focusing lens 208 are integrated together within housing 302 in the embodiment of FIG. 6. Compact white light source 202 emits light toward focusing lens 208, which concentrates the light on test sample 602.

Optically-active test sample 602 includes an optically-active test sample section 604 and a reflective section 606. Optically-active test sample section 604 absorbs light associated with the unknown compound while reflective section 606 reflects the non-absorbed light (“test light 608”) towards mode-matching lens 212. Test light 608 passes through mode-matching lens 212 to converge at the entrance slit 503 of spectrometer 502.

Test light 608 then diverges toward focusing lens 504 after passing through the entrance slit 503 of spectrometer 502. Focusing lens 504 directs test light 608 towards flat wavelength separator 412. Flat wavelength separator 412 splits or discriminates test light 608 into its constituent wavelength components 610 that are then directed towards detector array 218 via focusing lens 506. Each wavelength component 610 strikes a different pixel or group of pixels in detector array 218, thereby allowing detector array 218 to detect the intensity of light propagating at each received wavelength to identify or obtain information about the unknown compound.

All of the wavelength components 610 in test light 608 are wavelengths of interest that provide information about the unknown compound in an embodiment in accordance with the invention. In other embodiments in accordance with the invention, only one wavelength component 610 or a portion of the wavelength components 610 in test light 608 are wavelengths of interest that provide information about the unknown compound in an embodiment in accordance with the invention.

Embodiments in accordance with the invention are not limited to the configurations shown in FIG. 5 and FIG. 6. Systems 500 and 600 may be implemented with different components in other embodiments in accordance with the invention. For example, spectrometer 502 includes a curved dispersing element in another embodiment in accordance with the invention. For example, the dispersing element may be concave in shape to focus light onto detector array 218, thereby eliminating the need for focusing lens 506, focusing lens 504, or both focusing lenses 504, 506. Additionally, focusing lens 208 and mode-matching lens 212 are implemented with a single lens to converge test light 406 and 608 onto the entrance slit 503 of spectrometer 502 in yet another embodiment in accordance with the invention. And finally, a filter is inserted in front of entrance slit 503 of spectrometer 502 to transmit light in test light 406 and 608 that are propagating at or near the wavelengths of interest while simultaneously blocking light propagating at all other wavelengths in other embodiments in accordance with the invention.

FIG. 7 is a graphic illustration of a sixth system for measuring light propagating at multiple wavelengths in an embodiment in accordance with the invention. System 700 includes compact white light source 202, optically-active test sample 204, and spectrometer 702. Compact white light source 202 and focusing lens 208 are integrated together within housing 302 in the embodiment of FIG. 7.

Focusing lens 208 concentrates light from compact white light source 202 towards test sample 204. Optically-active test sample 204 absorbs at least some of the light and emits fluorescence or luminescence (“test light 210”) in response to the white light striking test sample 204. Test light 210 passes through mode-matching lens 212 to converge at the entrance slit 213 of spectrometer 702.

Test light 210 then diverges towards reflector 704 after passing through entrance slit 213 of spectrometer 702. Reflector 704 reflects test light 210 towards filter 706 and detector array 218. Reflector 704 is implemented as a curved mirror in an embodiment in accordance with the invention. Reflector 704 is implemented with different components in other embodiments in accordance with the invention.

Filter 706 is fabricated to allow only the portions of test light 210 propagating at or near the wavelength or wavelengths of interest to pass and strike detector array 218 while simultaneously blocking the portions of test light 210 propagating at all other wavelengths. Detector array 218 then detects the intensity of light propagating at each received wavelength of interest to identify or obtain information about the unknown compound in the test sample. Filter 706 is implemented as a narrow bandpass or spike filter with a sliding transmission wavelength along its surface in an embodiment in accordance with the invention. In other embodiments in accordance with the invention, filter 706 is implemented differently, such as, for example, as a dual-spike or tri-spike filter.

Embodiments in accordance with the invention are not limited to the configuration shown in FIG. 7. System 700 may be implemented with different components in other embodiments in accordance with the invention. For example, focusing lens 208 and mode-matching lens 212 are implemented with a single lens that converges test light 210 onto the entrance slit 213 of spectrometer 702 in other embodiments in accordance with the invention. And a filter may be inserted in front of entrance slit 213 of spectrometer 702 to transmit light in test light 210 that are propagating at or near the wavelengths of interest while simultaneously blocking light propagating at all other wavelengths in other embodiments in accordance with the invention.

1. A system for measuring test light received from an optically-active test sample, wherein the test light is propagating at multiple wavelengths and at least one of the multiple wavelengths comprises a wavelength of interest, the system comprising:
a white light source occupying a volume equal or nearly equal to ten cubic centimeters or less and operable to emit light towards the optically-active test sample;
a wavelength separator operable to receive the test light from the optically-active test sample and discriminate the multiple wavelengths in the test light; and
a detector array operable to receive light from the wavelength separator and detect an amount of light propagating at or near the at least one wavelength of interest.

2. The system of claim 1, further comprising one or more lenses positioned between the white light source and the optically-active test sample.

3. The system of claim 1, wherein the white light source comprises one of a white light-emitting diode, a white light-emitting xenon flash lamp, and a white light-emitting incandescent lamp.

4. The system of claim 1, further comprising a filter positioned between the white light source and the wavelength separator and configured to transmit the test light propagating at or near the at least one wavelength of interest.

5. The system of claim 1, further comprising one or more curved mirrors positioned between the optically-active test sample and the wavelength separator and operable to direct light towards the wavelength separator.

6. The system of claim 1, further comprising one or more lenses positioned between the optically-active test sample and the wavelength separator and operable to direct light towards the wavelength separator.

7. The system of claim 1, wherein the detector array comprises a silicon complementary metal oxide semiconductor detector.

8. The system of claim 1, wherein the wavelength separator comprises a diffraction grating.

9. The system of claim 1, wherein the wavelength separator comprises a prism.

10. The system of claim 1, wherein the wavelength separator comprises a filter configured to transmit the test light propagating at or near the at least one wavelength of interest while simultaneously blocking the test light propagating at other wavelengths.

11. The system of claim 1, wherein the light received from the optically-active test sample comprises one of fluorescence and luminescence emitted from the optically-active test sample.

12. The system of claim 1, wherein the light received from the optically-active test sample comprises one of light transmitted through and light reflected off the optically-active test sample.

13. A method for measuring test light received from an optically-active test sample, wherein the test light is propagating at multiple wavelengths and at least one of the multiple wavelengths comprises a wavelength of interest, the method comprising:
emitting light towards the optically-active test sample from a white light source occupying a volume equal or nearly equal to ten cubic centimeters or less, wherein the light substantially includes only white light;
receiving the test light from the optically-active test sample;
discriminating the multiple wavelengths in the test light; and
detecting an amount of light propagating at or near the at least one wavelength of interest.

14. The method of claim 13, wherein discriminating the multiple wavelengths in the test light comprises splitting the test light received from the optically-active test sample into its constituent wavelength components.

15. The method of claim 13, wherein discriminating the multiple wavelengths in the test light comprises transmitting the test light received from the optically-active test sample through a filter designed to transmit the test light propagating at or near the one or more wavelengths of interest while simultaneously not transmitting the test light propagating at other wavelengths.

16. The method of claim 13, further comprising absorbing at least a portion of the white light and emitting test light in response to the white light striking the optically-active test sample.

17. The method of claim 16, wherein the emitted test light comprises one of fluorescence and luminescence emitted from the optically-active test sample.

18. The method of claim 16, wherein discriminating the multiple wavelengths in the test light comprises discriminating the multiple wavelengths in the emitted test light.

19. The method of claim 13, further comprising absorbing at least a portion of the white light and reflecting non-absorbed test light in response to the white light striking the optically-active test sample.

20. The method of claim 19, wherein discriminating the multiple wavelengths in the test light comprises discriminating the multiple wavelengths in the non-absorbed test light reflected from the optically-active test sample.

21. The method of claim 13, further comprising absorbing at least a portion of the white light and transmitting the non-absorbed test light through the optically-active test sample in response to the white light striking the optically-active test sample.

22. The method of claim 21, wherein discriminating the multiple wavelengths in the test light comprises discriminating the multiple wavelengths in the non-absorbed test light transmitted through the optically-active test sample.
